(19) United States
(12) Patent Application Publication
(10) Pub. No.: US 2006/0051274 A1
(43) Pub. Date: Mar. 9, 2006

(54) Removal of carbon dioxide from air

(76) Inventors: Allen B. Wright, Tucson, AZ (US); Klaus S. Lackner, Dobbs Ferry, NY (US)

Correspondence Address: HAYES, SOLOWAY P.C., 3450 E. SUNRISE DRIVE, SUITE 140, TUCSON, AZ, 85718, US

(21) Appl. No.: 11/209,962

(22) Filed: Aug. 22, 2005

Related U.S. Application Data
(60) Provisional application No. 60/603,811, filed on Aug. 23, 2004.
(60) Provisional application No. 60/611,493, filed on Sep. 20, 2004.

(51) Int. Cl. B01D 53/62

(52) U.S. Cl. 423/220

(57) ABSTRACT

The present invention is directed to methods for removing carbon dioxide from air, which comprises exposing solvent covered surfaces to air streams where the airflow is kept laminar, or close to the laminar regime. The invention also provides for an apparatus, which is a laminar scrubber, comprising solvent covered surfaces situated such that they can be exposed to air stream. In another aspect, the invention provides a method and apparatus for separating carbon dioxide (CO₂) bound in a solvent. The invention is particularly useful in processing hydroxide solvents containing CO₂ captured from air.

### CROSS REFERENCE TO RELATED APPLICATIONS

This application claims priority from U.S. Provisional Application Ser. No. ______ filed Aug. 20, 2004, and from U.S. Provisional Application Ser. No. 60/603,811 filed Aug. 23, 2004, and from U.S. Provisional Application Ser. No. 60/611,493, filed Sep. 20, 2004, the contents of which are incorporated herein by reference.

### BACKGROUND OF THE INVENTION

The present invention in one aspect relates to removal of selected gases from air. The invention has particular utility for the extraction of carbon dioxide (CO₂) from air and will be described in connection with such utilities, although other utilities are contemplated.

Extracting carbon dioxide (CO₂) from ambient air would make it possible to use carbon-based fuels and deal with the associated greenhouse gas emissions after the fact. Since CO₂ is neither poisonous nor harmful in parts per million quantities but creates environmental problems simply by accumulating in the atmosphere, it is possible to remove CO₂ from air in order to compensate for equally sized emissions elsewhere and at different times. The overall scheme of air capture is well known.

The production of CO₂ occurs in a variety of industrial applications such as the generation of electricity power plants from coal and in the use of hydrocarbons that are typically the main components of fuels that are combusted in combustion devices, such as engines. Exhaust gas discharged from such combustion devices contains CO₂ gas, which at present is simply released to the atmosphere. However, as greenhouse gas concerns mount, CO₂ emissions from all sources will have to be curtailed. For mobile sources the best option is likely to be the collection of CO₂ directly from the air rather than from the mobile combustion device in a car or an airplane. The advantage of removing CO₂ from air is that it eliminates the need for storing CO₂ on the mobile device.

Various methods and apparatus have been developed for removing CO₂ from air. In one of these, air is washed with an alkaline solution in tanks filled with what are referred to as Raschig rings. For the elimination of small amounts of CO₂, gel absorbers have also been used. Although these methods are efficient in removing CO₂, they have a serious disadvantage in that for them to efficiently remove carbon dioxide from the air, the air must be driven by the sorbent at a fairly high pressure, because relatively high pressure losses occur during the washing process. Furthermore, in order to obtain the increased pressure, compressing means of some nature are required and these means use up a certain amount of energy. This additional energy used in compressing the air can have a particularly unfavorable effect with regard to the overall carbon dioxide balance of the process, as the energy required for increasing the air pressure would produce its own CO₂ that would have to be captured and disposed of.

Thus, the prior art methods result in the inefficient capture of CO₂ from air because these processes heat or cool the air, or change the pressure of the air by substantial amounts, i.e., the net loss in CO₂ is negligible as the cleaning process introduces CO₂ into the atmosphere as a byproduct of the generation of electricity used to power the process.

Furthermore, while scrubber designs for separating CO₂ from air already exist, generally they are limited to packed bed type implementations whose goal is typically to remove all traces of an impurity from another gas. One such device, described in U.S. Pat. No. 4,047,894, contains absorption elements comprising porous sintered plates made of polyvinylchloride (PVC) or carbon foam assembled spaced from one another in a housing. Prior to the plates being assembled in the housing, potassium hydroxide is impregnated in the porous plates. Such a device has the disadvantage that the sorbent material used to separate CO₂ from air cannot be replenished without disassembling the device housing.

In another aspect the present invention relates generally to methods and apparatus for separating carbon dioxide (CO₂) bound in a solvent. The invention has particular utility in connection with processing hydroxide solvents containing CO₂ captured from air (or other alkaline sorbents that are used to collect CO₂) and will be described in connection with such utilities, although other utilities are contemplated.

Processes that collect CO₂ from the air typically rely on solvents that either physically or chemically bind CO₂ from the air. A class of practical CO₂ solvents include strongly alkaline hydroxide solutions like, for example, sodium and potassium hydroxide. Hydroxide solutions in excess of 0.1 molarity can readily remove CO₂ from air where it is bound, e.g., as a carbonate. Higher hydroxide concentrations are desirable and an efficient air contactor will use hydroxide solutions in excess of 1 molar. Sodium hydroxide is a particular convenient choice, but other solvents such as organic amines may be used. Yet another choice of sorbents include weaker alkaline brines like sodium or potassium carbonate brines. The following discussion applies to all solvents that store CO₂ at least in part in an ionic carbonate or bicarbonate form.

The design of air contactor systems that aim to contact the air for CO₂ is dealt with in other patents and in the literature [1,2,3]. This aspect of the present invention relates to the recovery of the sorbent, wherein the CO₂ laden sorbent is rejuvenated and the CO₂ is separated from the liquid. We are describing a set of electrochemical processes that can be combined with an air capture unit to refresh the hydroxide solution and collect the CO₂ in a separate and in some cases pressurized stream.

All processes have in common that they separate sodium hydroxide from the carbonate or another salt by electrochemical means. While there are some electrolytical processes that involve only a pair of electrodes, most processes involve separation schemes that use bipolar membranes and/or at least one type of cationic or anionic membranes. In addition some of these processes involve conventional calcination and/or acid base reactions that lead to the evolution of gaseous CO₂. Several such processes are claimed in this invention and have been group into seven distinct classes as will be discussed below.

Thus, a purpose of this invention is to improve and streamline process designs for capture of carbon dioxide from air, which is an important tool in allowing the use of hydrocarbon fuels in a carbon constrained world. Many of these processes could also find use in other applications in which CO₂ bound into a hydroxide solvent has to be completely or partially removed from the solvent.

The disadvantages in the art are addressed and overcome by the CO₂ separation membranes and methods of use thereof as embraced by the present invention.

### SUMMARY OF THE INVENTION

The purpose of the removal of CO₂ from the air is to balance out the CO₂ emission resulting from, for example, the operation of vehicle or a power plant. While the most obvious source of CO₂ emissions that could be remedied by this invention are those for which it would be difficult or impossible to capture the CO₂ at the point of emission, the invention is not restricted to such sources but could compensate for any other source as well. Indeed this approach of CO₂ mitigation could be used to lower the atmospheric concentration of CO₂, if at some future time society deems the anthropogenic carbon dioxide concentration in the air too high.

While the goal of this invention is to capture carbon dioxide from air for purposes of managing the overall carbon dioxide budget of the atmosphere, the concepts would apply equally well if the reason for carbon dioxide capture from a gas with low concentrations of CO₂ is a different one. Examples include, capture for the purpose of the sale of CO₂ in the food industry or the oil industry, capture of carbon dioxide or other acid gases from dilute streams as they would occur in indoor air, in tunnels or other closed environments.

This invention in one aspect relates to an air scrubber device, a method of recovering CO₂ from the solvent utilized in the scrubber, and a business method for exploiting the above device and method of removing CO₂. The air scrubber according to this invention operates at a minimal air pressure drop and is effective in removing a large fraction of the CO₂ from the air that is flowing through the air scrubber. We refer to the scrubber design as a lamella design for reasons that become clear below. The lamella based air scrubber unit could become a module in a larger superstructure for funneling the air that can be modified to suit the particular design. The air can be driven by natural wind, by thermal convection or by fans.

In another aspect of the invention, a method and apparatus is proposed to recover the carbon dioxide that has been captured in the scrubber device. In nearly all air capture designs, the overall process of CO₂ capture from air requires an air contactor that removes CO₂ from the air by binding the CO₂ into a solvent or sorbent. The spent sorbent is then processed to recover all or part of the CO₂, preferably in a concentrated, pressurized stream. The rejuvenated solvent is recycled to the CO₂ collector.

This application lays out several processes for recovering an hydroxide based sorbent by means of electrochemical processes that can separate acids from base. Such processes exist and have been demonstrated for a variety of acids. Here we take these processes and combine them in such a way as to built a functional and efficient CO₂ recovery unit.

The invention is also concerned with several novel designs of unit processes that are specifically adapted to the application considered here.

The advantages of this invention are several: First, the process greatly streamlines the overall flow sheet of carbon dioxide capture from air, by avoiding the intermediate step of transferring the carbonate ion to calcium carbonate which is then calcined to free the CO₂. The mass handling of such a transfer process is complicated. Secondly, the more direct electrochemical process provides also a way of reducing the overall energy consumption. Thirdly it greatly reduces the need for complex, moving equipment to manage solid material streams, as would be necessary in a conventional calcium carbonate driven recovery unit.

Finally, we note that implementations of this type could also be used in systems that need to separate carbonate and hydroxide solutions that result from processes other than air extraction.

### BRIEF DESCRIPTION OF THE DRAWINGS

Further features and advantages of the present invention will be seen from the following detailed description taken in connection with the accompanying drawings wherein like numerals depict like parts, and wherein:

FIG. 1 is a perspective view of a air scrubber unit made in accordance with one preferred embodiment of the present invention;

FIG. 2 is a top plan view of the air scrubber unit of FIG. 1;

FIG. 3 is a front, i.e., air inlet view of the air scrubbing unit of FIG. 1;

FIG. 4 is a side elevational view of the air scrubber unit of FIG. 1;

FIG. 5 is a diagrammatic view of an apparatus for separating carbonate and hydroxide solutions in accordance with another aspect of the invention; and

FIGS. 6-13 are flow diagrams of various processes and process systems for separating carbonate and hydroxide solutions in accordance with the present invention.

### DETAILED DESCRIPTION OF THE INVENTION

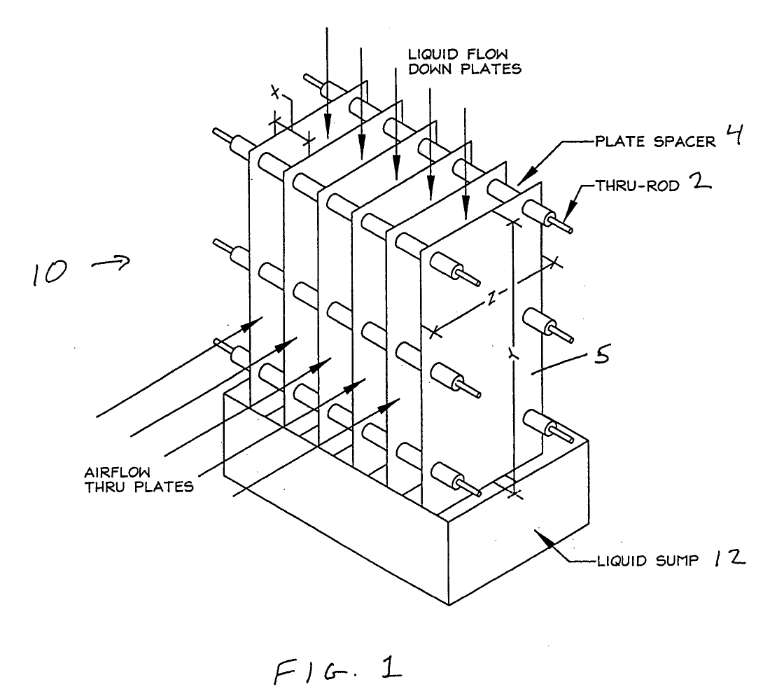

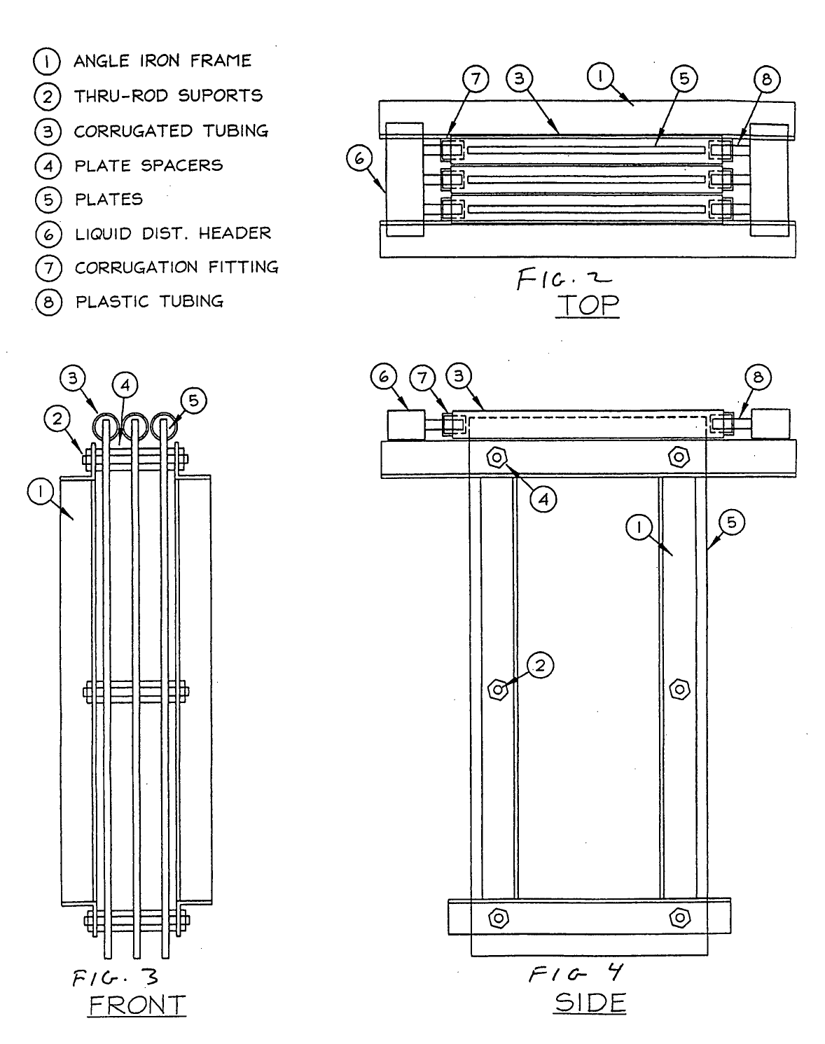

Referring first to FIGS. 1-4, an air scrubber unit according to one aspect of the present invention removes CO₂ from an airflow that is maintained by a low-pressure gradient. The air scrubber units consist of a wind collector 10 having lamella, which are two sheets or plates 5 covered in downward flowing sorbent bounding a thin air space, and a liquid sump 12. The two sheets forming the lamella preferably are separated by spacers 4 laced between the sheets on thru-rods 2 supported by a rigid frame 1 although the lamella may be supported in spaced relation by other means.

In general, the sorbent material flows down the lamella sheets, while the airflow passes between the thin airspace between the sheets. The contact between the air and the sorbent material causes a chemical reaction that removes CO₂. However, the air scrubber units could also capture other gases present in the air.

Sorbent is applied to the lamella sheets according to established state of the art approaches, e.g. spray nozzles or liquid extrusion, for example from corrugated tubing 3 fed from a header 6. Also, designs could wet vertical surfaces near the top and let gravity run the fluid over the surface until the entire area is covered. Alternatively, the surfaces could be shaped as flat disks which are wetted as they rotate through a sump. The motion would distribute the liquid along these surfaces.

Typical pressure gradients for moving the airflow across the lamella are such that they could be generated by natural airflows, e.g. wind, or thermal gradients. Pressure drops across the unit range from nearly zero to a few hundreds of Pascal, a preferred range is from 1 to 30 Pa and an optimal range may be from 3 to 20 Pa. However, fans either with or without ductwork to guide the air and convection could also be used to move the airflow.

The Lamella

The purpose of the wind collector is to bring the airflow into close contact with sorbent coated surfaces of the scrubber or wind collector. The basic unit of the wind collector is a single lamella which is a thin air space bounded by two sorbent covered sheets. In the most simple design the sheets are flat, but it is possible that the sheets are curved as long as the air passing over them can move in a straight line, i.e. the sheets curve in the direction normal to the wind flow. Each air scrubber device includes a means of distributing the sorbent on the sheets of the lamella and recapturing the spent sorbent.

The following is a list of exemplary designs for the wind chamber lamella:

1) Flat rectangular sheets or plates that are aligned parallel to each other.

2) Corrugated sheets that are lined up parallel to each other, with surfaces straight in the direction of air flow.

3) Flat disks rotating around a center axis with with the air flowing at right angle to the axis of rotation. Sorbent could be applied by the wheels dipping into fluid near the bottom of the circular motion. The standing sorbent may only cover the outer rim of the disks or reach all the way to the axle. Alternatively sorbent may be injected onto the rim by liquid wetting near the axle and flowing around the disk due to gravity and rotary motion.

4) Concentric tubes or similar shapes where air would be blowing along the tube axis. Such tubes could be arranged vertically for counterflow designs with wetting initiated at the upper rim or nearly horizontally with sorbent entering at one end and one point and getting distributed through a slow rotating motion of the tubes.

Airflows across the lamella may be natural wind flows, or they may be obtained by other means, for example through engineered thermal updrafts. However, high wind speeds would be counterproductive as higher speeds lead to higher rates of energy dissipation. Slow airflow speeds maximize air contact time with the sorbent material on the lamella while minimizing the loss of kinetic energy in the system. Thus, airflow velocities through the scrubber unit may range from virtually stagnant to a few tens of meters per second. A preferred range would be from 0.5 to 15 m/s an optimal range for wind driven systems ranges from 1 to 6m/sec.

Practically, the flow speed of the airflow through the wind collector needs to be a substantial fraction of the typical wind speed. The choice of better geometries may reduce the flow speed somewhat, but those enhancements will be factors of two not orders of magnitude.

In an exemplary embodiment of the invention, an airflow speed of 2 m/s is assumed, but airflow speeds may range from 0.5 m/s to about 4 m/s. At the nominal flow speed of 2 m/s, the flux of CO₂ per unit of wind area is 30 mmol/m³/s. The flux into the sodium hydroxide solution is limited to about 0.06 mmol/m²/s of hydroxide surface and the air side transport coefficient dominates for boundary layer thicknesses in excess of about 2 to 4 mm.

In this embodiment, the capture system is as compact as possible, and the size constraints determine the geometry of the apparatus. Placing flat absorbing sheets approximately 0.5 cm apart provides nearly 500 m² of sheet surface area inside a cubic meter. The actual length is approximately 1.2 m plus an allowance for the finite thickness of the sheets. It is possible to obtain a slightly larger sheet surface area if the sheets are folded or shaped into tubes. However, since the liquid sorbent flows from the top of the wind collector to the bottom, flat vertical sheets are a natural choice because sheets that have breaks or folds would deflect the passing air to add turbulence to the system and reduce the boundary layer thickness. Since the flat plates already operate at the optimal boundary layer thickness, such turbulence would not improve the CO₂ uptake performance, but it would increase the energy dissipated in the device.

However, a very large system is also contemplated that, for structural reasons, might have a wind collector design with a depth greater than 1 meter. Such a device would still be optimized to 500 m² of sheet surface per square meter of frontal opening. In this embodiment, the natural spacing between plates would exceed the optimal boundary layer thickness and thus the introduction of shapes that cause turbulence would be necessary. The turbulence would drive the boundary layer thickness back to the desired value of 2 to 4 mm. For example a 20 m deep filter system, would require about 25 m² of packing per cubic meter. And, the typical spacing for the sheets would be about 8 cm, far too large for an optimal boundary layer. Creating eddies at the centimeter scale would in effect reduce the boundary layer thickness and thus provide the necessary airside CO₂ flux.

The flow through a 1 m deep unit with sheets or plates 0.6 cm apart would be laminar up to relatively high flow velocities. If the Reynolds number is defined as

$$Re = \frac{ρdv}{η} \qquad ( 1 )$$

the laminar regime extents to about 1400. In other words, for plates spaced at a distance of 0.6 cm apart, the flow remains laminar to about 4 m/s. In the following, the resistance to the airflow in such a stack of plates was calculated.
The pressure drop per unit length is given by:

$$\frac{\partial P}{\partial x} \qquad ( 2 )$$

If the pressure across a plane normal to the two side walls is assumed to be constant, then the force on a parcel of air of with width Δy, height h, and depth Δx is given according to the literature by

$$\begin{matrix}Δ yh \frac{\partial P}{\partial x} Δ x = - η ( \frac{{\partial }^{2} v}{\partial {y}^{2}} Δy ) hΔx or & ( 3 ) \\ \frac{{\partial }^{2} v}{\partial {y}^{2}} = \frac{1}{η} \frac{\partial P}{\partial x} or & ( 4 ) \\ v ( y ) = - \frac{1}{2 η} \frac{\partial P}{\partial x} {y}^{2} + {C}_{1} y + {C}_{2} & ( 5 )\end{matrix}$$

The two integration constants follow from the two boundary conditions, namely
v(0)=v(d)=0 (6)
From that we obtain

$$v ( y ) = \frac{1}{2 η} \frac{\partial P}{\partial x} y ( d - y ) \qquad ( 7 )$$

The peak velocity between the plates is therefore,

$${v}_{max} = \frac{{d}^{2}}{8 η} \frac{Δ P }{L} \qquad ( 8 )$$

where L is the length of the plate and ΔP the pressure drop across this distance. The average flow velocity is given by

$$\begin{matrix}\overline{v} = \frac{1}{d} {\int }_{0}^{d} v ( y ) ⅆ y = \frac{{d}^{2}}{12 η} \frac{Δ P}{L} or & ( 9 ) \\ Δ P = \frac{12 ηL}{{d}^{2}} \overline{v} or & ( 10 ) \\ L = \frac{Δ {Pd}^{2}}{12 η \overline{v}} & ( 11 )\end{matrix}$$

If we want to determine L such that

$$\begin{matrix}\frac{ρ \overline{{v}^{2}}}{2} = Δ P then & ( 12 ) \\ L = \frac{ρ \overline{v} {d}^{2}}{24 η} = \frac{Re}{24} d we find that at v = 2 m \text{/} s , L = 0.2 m & ( 13 )\end{matrix}$$

More generally, a design rule would be that
d/L˜24/Re (14)
where Re is the Reynolds number of the flow. And, the flow between plates is affected by fluctuations in the distance between the plates. Note that the mass flow per unit width of the system is given by

$$Q = ρ \overline{v} d = ρ \frac{{d}^{3}}{12 η} \frac{\partial P}{\partial x} \qquad ( 15 )$$

If we assume that Q is a constant and d is a function of x, then we find

$$Δ P = \frac{12 ηQ}{ρ} {\int }_{0}^{L} \frac{ⅆ x}{ⅆ {( x )}^{3}} \qquad ( 16 )$$

In a simplified case, the width on one half the lamella is d₁ and on the other half it is d₂. We furthermore assume that

$${d}_{1} + {d}_{2} = 2 d and \frac{{ⅆ}_{2}}{{ⅆ}_{1}} = α or {d}_{1} = \frac{2 d}{1 + α} and {d}_{2} = \frac{2 d}{1 + 1 / α} \qquad ( 17 )$$

With that we find that

$$Δ P = \frac{12 η L}{ρ {d}^{3}} \frac{{d}^{3}}{2} ( \frac{1}{{d}_{1}^{3}} + \frac{1}{{d}_{2}^{3}} ) = \frac{12 η L}{ρ {d}^{3}} \frac{( {( 1 + α )}^{3} + {( 1 + 1 / α )}^{3} )}{16} \qquad ( 18 )$$

The correction factor is 1 for α=1, but it rises to 1.89 for α=2 . In a fully three-dimensional system where the air can flow around a narrow spot the total constriction is actually smaller.

Note, the equations derived above only apply to fully developed laminar flow between the plates. However there is a section at the onset of the plates where the flow is not fully developed. In that region the pressure drop is best characterized by the drag on the separate plates. As the boundary layer thickness increases and the boundary layers from adjacent plates start to overlap the flow develops into the steady flow pattern observed between two plates.

The drag per unit width on one side of an infinitely thin plate is given by

$${F}_{drag} = {C}_{d} \frac{ρ}{2} {xv}^{2} \qquad ( 19 )$$

where x is the distance from the beginning of the plate. The drag coefficient C_{d} is given according to the literature by
C_{d}=1.308Reₓ^{-1/2}=1.308η^{1/2}ρ^{-1/2}v^{-1/2}x^{-1/2} (20)
The pressure drop across a set of parallel plates short enough that they do not yet interfere with each other would be given by

$$P ( 0 ) - P ( x ) = {C}_{d} \frac{ρ}{2} {xv}^{2} \frac{1}{d} \qquad ( 21 )$$

where d is the spacing between the infinitesimally thin plates or
P(0)−P(x)=1.308η^{1/2}ρ^{1/2}v^{3/2}x^{1/2}d⁻¹ (22)
In the onset the airflow looks different as the boundary layers affected by the onset are smaller.

Furthermore, in one particular design one might have an ambient wind velocity v₀. In front of the lamellae the air stagnates and slows down to a velocity v. The pressure for driving the air through the lamellae is given by

$$\begin{matrix}\frac{ρ}{2} ( {v}_{0}^{2} - {v}^{2} ) = \frac{12 η Lv}{{d}^{2}} or & ( 23 ) \\ \frac{ρ}{2} {v}^{2} + \frac{12 η L}{{d}^{2}} v - \frac{ρ}{2} {v}_{0}^{2} = 0 & ( 24 ) \\ v = \sqrt{{v}_{0}^{2} + {( \frac{12 η L}{ρ {d}^{2}} )}^{2}} - \frac{12 η L}{ρ {d}^{2}} & ( 25 )\end{matrix}$$

Of the two solutions to the quadratic equation, we chose the only physical solution, i.e., the one that is positive.
The Sorbent

The rate of uptake Of CO₂ into a strong hydroxide solution has been well studied. The air scrubber of the instant invention is a device that will pull CO₂, or other gas, directly out of a natural wind flow, or out of a flow subject to a similar driving force, e.g., a thermally induced convection.

CO₂ uptake into a strong hydroxide solution involves a chemical reaction that greatly accelerates the dissolution process. The net reaction is
CO₂(dissolved)+2OH⁻→CO₃⁻⁻+H₂O (26)
There are several distinct pathways by which this reaction can occur. The two steps that are relevant at high pH are
CO₂(dissolved)+OH⁻→HCO₃⁻ (27)
followed by
HCO₃⁻+OH⁻→CO₃⁻⁻+H₂O (28)
The latter reaction is known to be very fast; the first reaction on the other hand proceeds at a relatively slow rate. The reaction kinetics for reaction (2) is described by

$$\frac{ⅆ}{ⅆ t} [ {CO}_{2} ] = κ [ {OH}^{-} ] [ {CO}_{2} ] \qquad ( 29 )$$

Hence the time constant describing the reaction kinetics is

$$τ = \frac{1}{κ [ {OH}^{-} ]} \qquad ( 30 )$$

The rate constant K has been measured at 20° C. and infinite dilution,
κ=5000 liter mol⁻¹s⁻¹=5 m³ mol⁻¹s⁻¹ (31)
The ionic strength correction is given by
κ=κ_{∞}10^{0.13 A} (32)
At high concentration of CO₂ in the gas, the rate of reaction (2) limits the rate of uptake, even though the time constant for a one molar solution at 0.14 ms is quite short.

Following standard chemical engineering models, e.g. Dankwert or Astarita, one can describe the transfer process in which a gas component is dissolved or chemically absorbed into a sorbent with a standard model that combines a gas-side flow transfer coefficient and a liquid side transfer coefficient to describe the net flow through the interface. The total flux is given by
F=κ_{G}(ρ(x=−∞)−ρ(x=0))=κ_{L}(ρ′(x=0)−ρ′(x=∞)) (33)
where ρ and ρ′ are the molar concentrations of CO₂ in the gas and in the solution respectively. The parameter x characterizes the distance from the interface. Distances into the gas are counted negative. At the boundary Henry's law applies, hence
ρ′(0)=K_{H}ρ(0) (34)
Expressed as a dimensionless factor, K_{H}=0.7.¹ For the gas side the transfer constant can be estimated as

$${κ}_{G} = \frac{{D}_{G}}{Λ} \qquad ( 35 )$$

where Λ is the thickness of the laminar sublayer that forms on the surface of the interface. The thickness of this layer will depend on the geometry of the flow and on the turbulence in the gas flow. Assuming the geometry of the flow and the turbulence in the gas flow is given, then the optimal choice for Λ must be determined.

For a fluid package, the standard approach to estimating the transfer coefficient assumes a residence time τ_{D} for the parcel on the surface of the fluid. This time results from the flow characteristic of the sorbent and it include surface creation and surface destruction as well as turbulent liquid mixing near the surface.
λ=\sqrt{Dτ_{D}} (36)
Since diffusion in the time τ_{D} can mix the dissolved CO₂ into a layer of thickness the flux from the surface is given by

$$F = {D}_{L} \frac{\partial {ρ}^{′}}{\partial x} \qquad ( 37 )$$

where D_{L} is the diffusion constant of CO₂ and ρ′ the liquid side concentration of CO₂. The gradient is evaluated at the surface. The transfer coefficient of the liquid is defined from the equation
F=κ_{L}(ρ′(x=0)−ρ′(x=∞)) (38)
Approximating the gradient by

$$\frac{\partial ρ}{\partial x} = \frac{{ρ}^{′} ( 0 ) - {ρ}^{′} ( ∞ )}{λ} \qquad ( 39 )$$

shows that for a diffusion driven absorption process

$${κ}_{L} = \frac{{D}_{L}}{λ} = \sqrt{\frac{{D}_{L}}{{τ}_{D}}} \qquad ( 40 )$$

Here D_{L} is the diffusion rate of CO₂ in the sorbent.

In the presence of a fast chemical reaction where the reaction time τ_{R}<<τ_{D}, the layer that absorbs CO₂ is characterized by this shorter time, hence the transfer coefficient is given by

$${κ}_{L} = \sqrt{\frac{{D}_{L}}{{τ}_{R}}} \qquad ( 41 )$$

In the presence of a chemical reaction the transfer coefficient is thus increased therefore by a factor

$$\sqrt{\frac{{τ}_{D}}{{τ}_{R}}} \qquad ( 42 )$$

However, this enhancement can only be maintained if the supply of reactant in the sorbent is not limited. In the case of CO₂ neutralizing a hydroxide solution, it is possible to deplete the hydroxide in the boundary layer. The layer thickness λ contains an area density of hydroxide ions of ρ_{OH}λ and the rate of depletion is 2κ_{L}ρ′CO₂: Thus for the fast reaction limit (eqn. 41) to apply

$$\frac{{ρ}_{{OH}^{-}}}{2 {ρ}_{{CO}_{2}}^{′}} \frac{{τ}_{R}}{{τ}_{D}} ⪡ 1 \qquad ( 43 )$$

In our case

$${ρ}_{{OH}^{-}} {τ}_{R} = \frac{1}{κ} \qquad ( 44 )$$

Hence the condition can be rewritten as
2ρ′_{CO}_{₂}κτ_{D}>>1 (45)

The critical time for transitioning from fast reaction kinetics to instantaneous reaction kinetics is approximately 10 sec for ambient air. The transition does not dependent on the hydroxide concentration in the solution. However, once past the transition, the rate of uptake is limited by the rate at which hydroxide ions can flux to the surface. It is therefore lower than in the fast limit, and the CO₂ flux is given by

$$F = \frac{1}{2} \sqrt{\frac{{D}_{{OH}^{-}}}{{τ}_{D}}} {ρ}_{{OH}^{-}} \qquad ( 46 )$$

In the instantaneous regime the flux is independent of the CO₂ concentration in the boundary layer. The flux can be characterized by an effective transfer coefficient, which can be written as
F=κ_{eff}(ρ_{CO}_{₂}−ρ′_{CO}_{₂}/K_{H}) (47)
Here the molar concentrations are for the asymptotic values in the far away gas and far away liquid. In the case of hydroxide solutions, the latter is zero. Hence,

$$\begin{matrix}F = {κ}_{eff} {ρ}_{{CO}_{2}} and & ( 48 ) \\ {κ}_{eff} = {( \frac{1}{{κ}_{G}} + \frac{1}{{κ}_{L} {K}_{H}} )}^{- 1} & ( 49 )\end{matrix}$$

An optimal design is close to the border between gas side limitation and liquid side limitation. Therefore, we establish a design value for the air side boundary thickness.

$$Λ \approx \frac{{D}_{G}}{\sqrt{{D}_{L} / {τ}_{R}}} \qquad ( 50 )$$

This is approximately 4 mm for air based extraction of CO₂.

These constraints together very much limit a practical design. For a 1 molar solution, the total solution flow has been measured as 6×10⁻⁵ mol m⁻² s⁻¹, which translates into an effective value of 0.4 cm/s which is close to the theoretical value.

As for types of sorbents that absorb CO₂ , there are a wide variety of options that can be used. In one embodiment, aqueous hydroxide solutions are used as the sorbent material. These would tend to be strong hydroxide solutions above 0.1 molar and up to the maximum possible level (around 20 molar).

The hydroxides used as a sorbent could be of a variety of cations. Sodium hydroxide and potassium hydroxides are the most obvious, but others including organic sorbents like MEA, DEA etc. are viable possibilities. Furthermore, the hydroxides need not be pure, they could contain admixtures of other materials that are added to change or modify various properties of the sorbent. For example, additives may improve on the reaction kinetics of the hydroxide with the CO₂ from the air. Such catalysts could be surfactants or molecules dissolved in the liquid. Additions of organic compounds like MEA are just one example. Other additives may help in reducing water losses by making the solution more hygroscopic. Yet other additives may be used to improve the flow or wettability characteristic of the fluid or help protect the surfaces from the corrosive effects of the hydroxide solution. In addition, any sorbent used in the invention must wet the surfaces of the lamella sheets. To this end, there are various means known in the art. These include surface treatments that increase hydrophilicity, surfactants in the sorbent and other means.

Design considerations

The invention includes the following important design features:

1) Lamella sheets are substantially smooth in the direction of the airflow on a size scale consistent with the size sheet separation. (However, incidental-or engineered structures on a much finer scale may be used to improve the CO₂ transport coefficient.) Variations in shape that are at right angles to the airflow, are of relatively little concern, as long as they do not interfere with the efficient wetting of the plates, sheets or surfaces;

2) The sheets are held in place sufficiently tightly or rigidly such that their flexing or flapping does not significantly reduce pressure variations between the lamellae.

3) Airflow through openings in the surfaces is inhibited so that it cannot significantly influence pressure variations between the lamellae.

4) The spacing between the lamellae is chosen such that the system does not transition out of the laminar flow or at least does not deviate much from that regime.

5) The depth of the membrane units is kept short enough to avoid nearly complete depletion of the air in the front part of the unit.

6) For utilization of both sides of the sheets it is preferable to arrange the lamella vertically. However, deviations from such a design could be considered for other flow optimizations.

7) The height of the lamella is chosen to optimize wetting properties of the surfaces and to minimize the need for reprocessing the fluid multiple times.

The Building Blocks of the CO₂ Recovery System.

In another aspect of this invention, the following electrochemical processes may be utilized in the CO₂ capture systems described in this invention, or in any other device that has collected CO₂. These electrochemical processes are all based on the separation of a salt into its acid and base, where the acid and the base stay in solution, by means of electrodialysis with bipolar membranes. Examples include the formation of sodium hydroxide and hydrochloric acid from sodium chloride, and the formation of sodium hydroxide and acetic acid from sodium acetate. Other combinations of acid and base have also been demonstrated in the literature, in the patent literature and in industrial practice. In the context of this invention, units of this type will be used to separate a hydroxide and carbonate solution, as well as units that separate the salt of a weak acid into the corresponding acid and base.

In the following we describe a number of processing steps which become the basic building blocks of the processes we consider.

1. The separation of a mixture of sodium hydroxide and sodium carbonate electrochemically into sodium hydroxide and sodium carbonate. For this process step we can rely on existing building blocks or use specifically designed units using electro-dialysis for the separation. These techniques also can be extended to other cations than sodium, such as, but not limited to potassium and ammonia, and the cations of organic amines, such as monoethanolamine (MEA), diethanolamine (DEA) and the like. The basic reaction in all cases is the separation of a mixture of R—OH and R₂CO₃ through a membrane process into separate solutions of R—OH and RHCO₃.

2. The electrochemical separation of a metal bicarbonate into the metal carbonate and CO₂. This process preferably uses electrodialysis involving bipolar membranes, but other electrolytic processes have been described in the literature and may be used.

3. The separation of the metal bicarbonate into the metal hydroxide and CO₂. Again this process preferably relies on electrodialysis with bipolar membranes, but it also could be accomplished by electrolysis of metal bicarbonate producing hydrogen that is reused in a hydrogen electrode producing CO₂.

4. Units that combine two or more of the above building blocks 2 and 3 or 4 into a single unit. For example, processes that take a mixture of carbonate and hydroxide all the way to a hydroxide solution and CO₂ gas.

The following are additional building blocks that do not involve electrochemistry:

1. A membrane process that uses concentration gradients to separate cations such as sodium from the solvent to reduce or eliminate the hydroxide in the input solvent. In some cases this unit could partially transform the solvent from carbonates into bicarbonates.

2. Temperature swing processes to separate sodium carbonate from a mixture of sodium carbonate and sodium hydroxide via precipitation.

3. Processes that take bicarbonate solutions to carbonate solutions by thermal or pressure swing. Such processes are conventionally deployed in certain CO₂-scrubbing systems that operate at CO₂ pressures sufficiently high for the reaction between sodium or potassium carbonate and CO₂ to form bicarbonates.

4. Processes that take bicarbonate solutions and use evaporation or thermal swings to precipitate bicarbonate from solution.

5. Processes for the calcination of bicarbonate to carbonate. Specifically of interest here are sodium or potassium bicarbonates.

6. A process that mixes an acid with hydroxide-carbonate mixture to neutralize the mixture and to form solid precipitates of these salts. The process can stop either at pure carbonate or move on to form carbonate/bicarbonate mixtures or move all the way to bicarbonate.

7. A process that uses an acid to drive all CO₂ out of the bicarbonate, or carbonate or hydroxide mixture. This process can be performed at elevated pressure in order to deliver the CO₂ at pipeline pressure.

An Outline of the Overall Process Schemes

All processes begin with the extraction of carbon dioxide from air in a unit that here is not further specified. A specific implementation has been dealt with in another aspect of this invention, The details of this unit are not of interest here, other than to note that this unit will consume a hydroxide based solvent that is fully or partially converted into a carbonate. It may be possible to convert the solvent partially into a bicarbonate. In this latter case on may also consider the use of carbonate as the starting solvent. The input solvent may contain other chemicals than just the hydroxide. For example it could contain certain additives that improve the process performance, but in particular it could contain residual carbonate from previous process cycles.

The purpose of this section of the invention is to outline processes and methods for recycling the solvent and a partial or complete recovery of the CO₂ into a concentrated stream preferably at a pressure suitable for subsequent processing steps. In the following discussion for the sake of clarity we will refer to specific hydroxides and specific acids. However, we emphasize that the process is not limited to these specific chemicals but can easily be generalized to encompass other ionic species.

In the following example the air contactor unit uses a sodium hydroxide solution whose concentration is in excess of one mole per liter of sodium hydroxide. Some remnant carbonate may still be in the solvent from the previous process cycle but as the solvent is exposed to air, hydroxide is converted into carbonate and the carbonate concentration of the solution starts rising until further conversion would not be desirable. There are several reasons for stopping the absorption process. In particular the process may be stopped because the hydroxide is exhausted, or the carbonate concentration reaches saturation levels. For most capture designs precipitation of carbonate in the absorber would be undesirable. The resulting carbonate solution is then returned from the capture unit for further processing.

Conceptually one can consider three steps in the recovery process as follows:

1. Separation of unconverted hydroxide from the carbonate;

2. Decomposition of sodium carbonate into sodium hydroxide and sodium bicarbonate, which is an acid base decomposition; and

3. Decomposition of sodium bicarbonate into sodium hydroxide or sodium carbonate and carbonic acid.

In some implementations these steps could be combined together into two process steps or even a single process step.

Alternatively, one can accomplish each of these steps by neutralizing the base, (here sodium) with a weak acid. If the sodium salt of the acid precipitates, then the process can be stopped at any point because it is straightforward to separate the acid anion in its precipitated form from the liquid; otherwise the neutralization process has to run to completion in which case the result is gaseous CO₂ and the salt of the base. If the air capture uses sodium hydroxide and the acid is acetic acid, the result would be sodium acetate. The resulting sodium acetate would be separated into sodium hydroxide and acetic acid. Both of them are recycled. The decomposition of sodium acetate is best accomplished with electrodialysis units encompassing bipolar membranes. If a high pressure CO₂ is required an acid stronger than acetic acid is required.

Process 1:

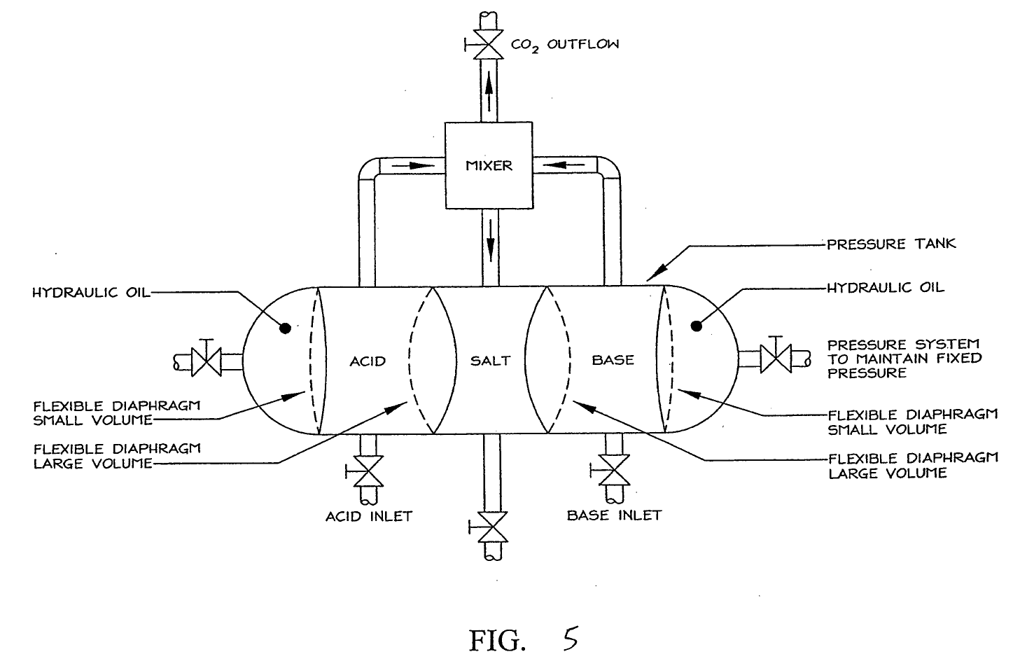

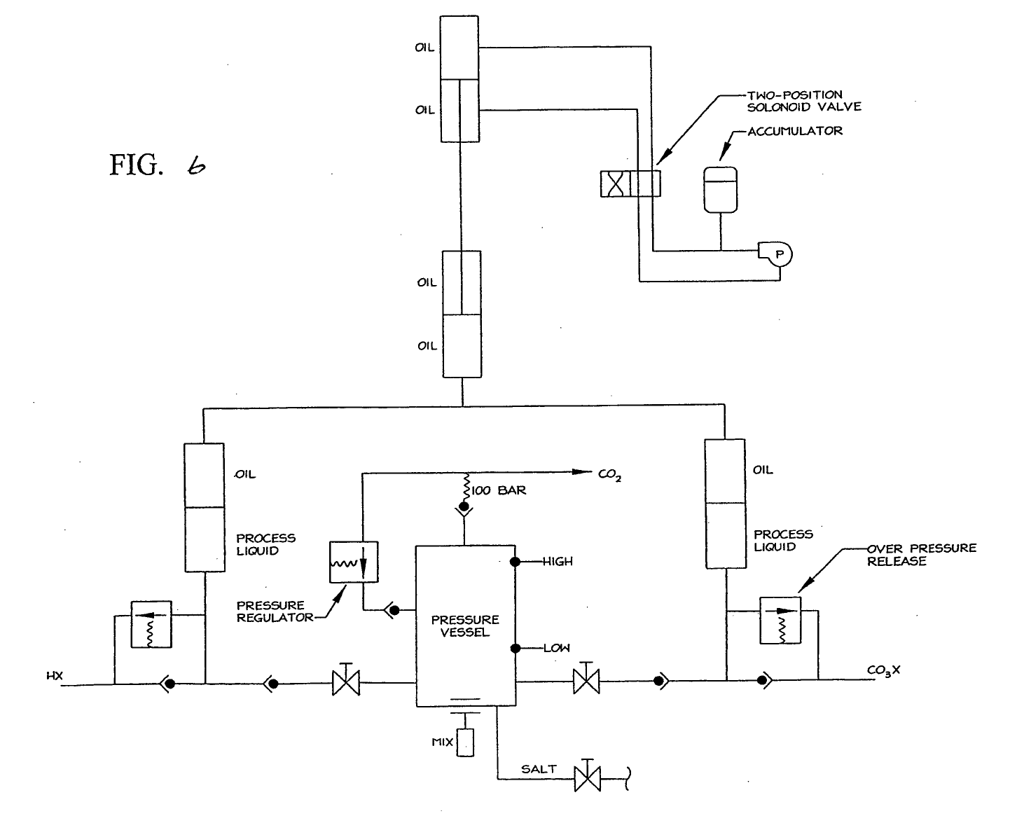

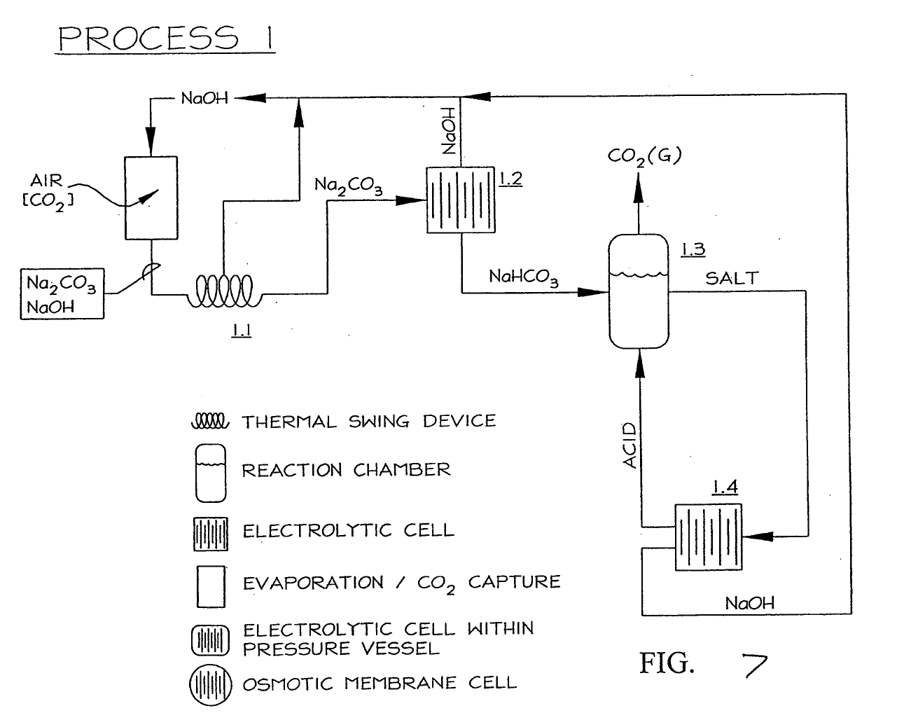

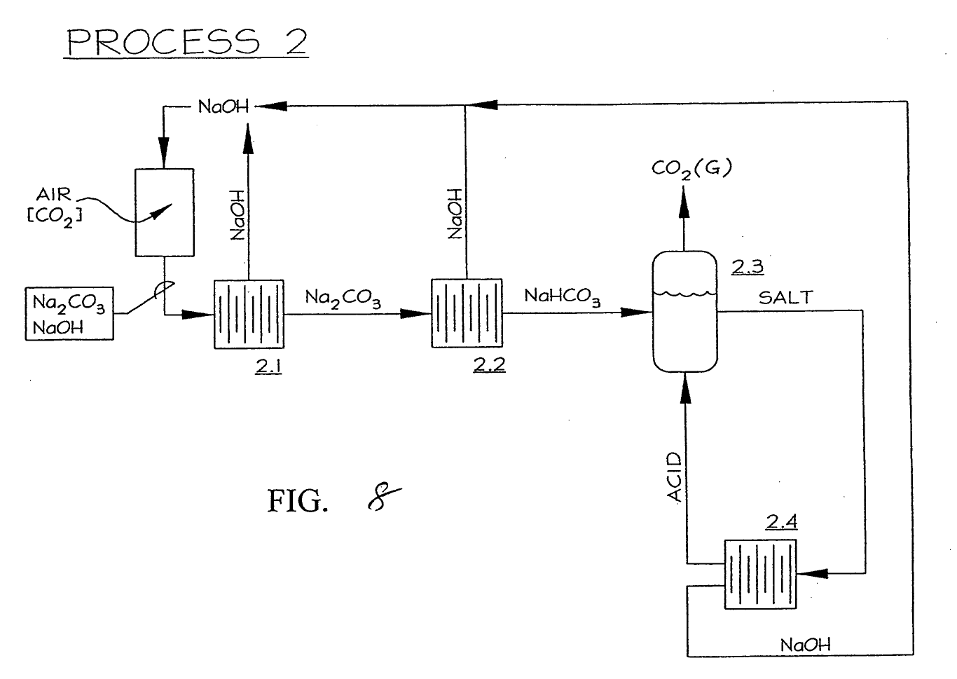

Referring to FIGS. 5-7, process 1 breaks the upgrading of the solvent into three distinct steps. First it separates a large fraction of the carbonate from the brine. Then it uses an electrochemical step to in effect withdraw sodium ions from the brine leading to sodium hydroxide and sodium bi-carbonate. Finally the resulting sodium bicarbonate releases its CO₂ under addition of an acid, which again is recycled in an electrochemical step. The advantage of this process implementation is that it combines high energy efficiency, with the ability to produce pressurized CO₂. It s an advantage of the electrochemical separation that carbon dioxide can be delivered at elevated pressure.

Step 1.1

Extract sodium carbonate from the spent solvent by a temperature swing. Sodium carbonate solubility is far smaller than that of sodium hydroxide. (Similar reasoning applies to some of the other hydroxides, but this implementation is limited to those for which the solubility ranges match). Consequently, for concentrated hydroxide solutions the maximum amount of sodium carbonate that can converted to sodium carbonate by CO₂ absorption is limited. One disadvantage of operating at high sodium hydroxide concentrations is that the spent solvent is still dominated by sodium hydroxide, which should not be processed through a number of expensive stages. The temperature swing method overcomes this problem, because it allows one to separate the carbonate without having to pass all sodium hydroxide through membrane systems. If the spent solution is nearly saturated in sodium carbonate, one can extract a fraction of the carbonate through precipitation. Solubility of sodium carbonate changes by more than a factor of three between 0° C. and 25° C. Thus it is possible to refresh the sodium hydroxide solution through a temperature swing, with heat exchange between the incoming fluid and outgoing fluid. This approach could utilize ambient heat in warm dry climates where the maximum temperature swing is large. The refreshed hydroxide solution is sent back to the air contactor unit. This approach also is more advantageously deployed in dry climates where high NaOH concentrations would help to reduce the concurrent water losses.

Step 1.2

The sodium carbonate precipitate is dissolved in water at maximum concentration. The sodium carbonate is processed further in an electrochemical unit for acid/base separation that can separate sodium carbonate into sodium hydroxide (the base) and sodium bicarbonate (the acid). There are several different designs possible for this electrochemical separation. Some are conventional and state of the art generic separators for acid and base that use bipolar membranes. Others involve hydrogen electrodes. Below we describe a particular unit specifically designed for sodium carbonate disassociation.

Step 1.3

The bicarbonate solution resulting from Step 1.2 is injected into a pressure vessel where it mixes with a weak acid. Preferred acids include citric, formic and acetic acid. However, the invention is not limited to any specific acid. The acid-base reaction drives carbonic acid out of the salt. The carbonic acid then decomposes into CO₂ and water. CO₂ at first dissolves into the brine but soon reaches a pressure that exceeds the container pressure, leading to the release of a pressurized CO₂ stream. The design constraints on this unit put some limits on the choice of an acid. Most importantly, the acid needs to be strong enough to drive CO₂ out of the solution, even at the design pressure. For a further discussion of this unit see below. The advantage of such a system is that it allows the release of concentrated CO₂ at pipeline pressure without having to put a large electrochemical unit into a pressure vessel. Left behind is a brine of the salt of the weak acid. This could be sodium acetate, sodium citrate or any other salt of a weak acid.

Step 1.4

The salt of the weak acid and the base used in the capture is decomposed in an electro-dialysis unit utilizing cationic, anionic and bipolar membranes to recover sodium hydroxide and the weak acid. There are several variations of this unit that could be used. With the conclusion of Step 1.4 the CO₂ is recovered, and the residual sodium hydroxide is returned to the overall cycle. In choosing among various design options, it is advantageous to use a unit that removes sodium ions from the solution rather than removing the anion from the solution, as it would generally be undesirable to send residual anions into the air contactor. This also makes it possible to control the concentration of the sodium hydroxide brine. Depending on the detailed conditions of the implementation, this last unit can therefore be used to adjust the water content of the sodium hydroxide to match what is desired in the air contactor. While we refer here generally to a weak acid, because the electrodialysis process requires less energy in recovering a weak acid, we note that the process in principle also works with a strong acid. In some special cases strong acids may have other advantages that overcome the inherently higher electrochemical potential. For example some membranes can sustain larger currents on simple ions of strong acids, then on larger organic acids.

Process 2:

Referring to FIG. 8, this process is very similar to Process 1, but it replaces the first step with a membrane separation system. This will create a relatively dilute NaOH solution that in turn needs to be concentrated. It could be used in subsequent steps as the starting brine on the hydroxide side of the membrane. Process 2 works particularly well, if the air extraction step has led to evaporative water losses from the solvent and thus additional water needs to be added to the solvent in any case.

Step 2.1:

Use a periodic system of cells with dilute NaOH solutions alternating with concentrated NaOH/Na₂CO₃ brine. On the one side the cells are separated by a cationic membrane and on the other by a bipolar membrane. The last cell is connected to the first cell making the system periodic. A design could be reduced to a simple pair of cells, but geometrical constraints generally favor a multiple cell system. As the sodium diffuses through the cationic membrane, charge neutrality of the cells demands that the bipolar membrane provide an H⁺—OH⁻ pair. The H⁺ neutralizes the left behind OH⁻; the OH⁻ forms a base with the withdrawn sodium in the other chamber. To a first approximation, the sodium concentration in the two chambers will balance out, suggesting that this separation can be performed without electric power input if at least half of the NaOH in the spent solvent has been converted into sodium carbonate. If this is not the case, it is still possible to use this system to partially reduce the NaOH concentration, or if one is willing to increase the water content of the solution, one can transfer a larger fraction of the sodium ions into the new hydroxide chamber which needs to maintain a sodium ion concentration that is lower than the remaining sodium ion concentration in the carbonate side of the system. Diluting the brine at this point may actually be desirable, as many air contactor designs will have lost some of the water that was originally in the solution. However, process step 2.2 which is the direct analog of process step 1.2 can also proceed if the extraction of NaOH was not entirely complete.

By taking a number of these cell arrangements (without closure at the end) and incorporating them into a stack that is used in step 2.2 to generate sodium bicarbonate, one can harness the power of the concentration driven cells to partially provide the driving expression for the second step in the conversion (FIG. 8).

Step 2.2

This process is very similar as Step 1.2 above. The difference is that the sodium carbonate is delivered in dissolved form, and it is likely that there is residual sodium hydroxide left in the input brine.

Step 2.3 and Step 2.4

The same as Steps 1.3 and 1.4.

Process 3

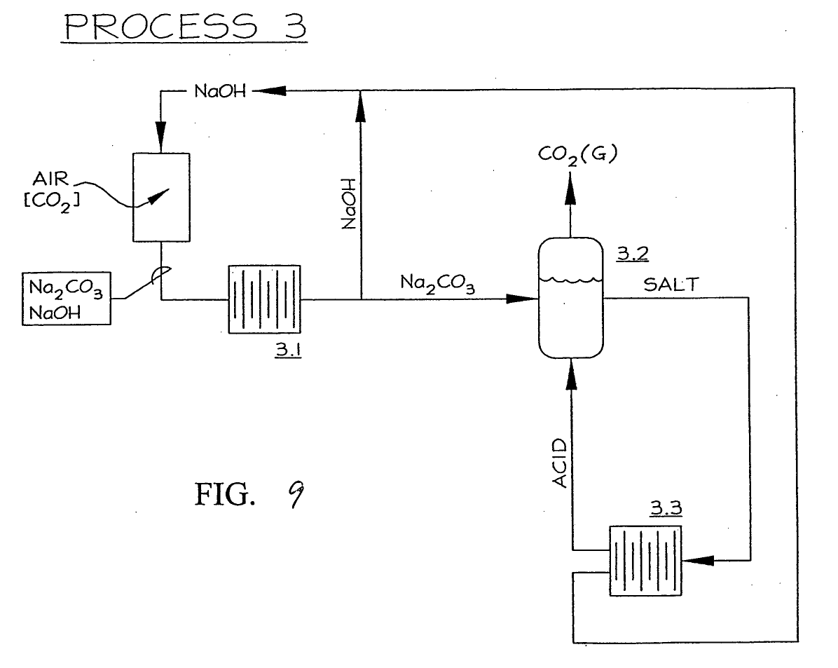

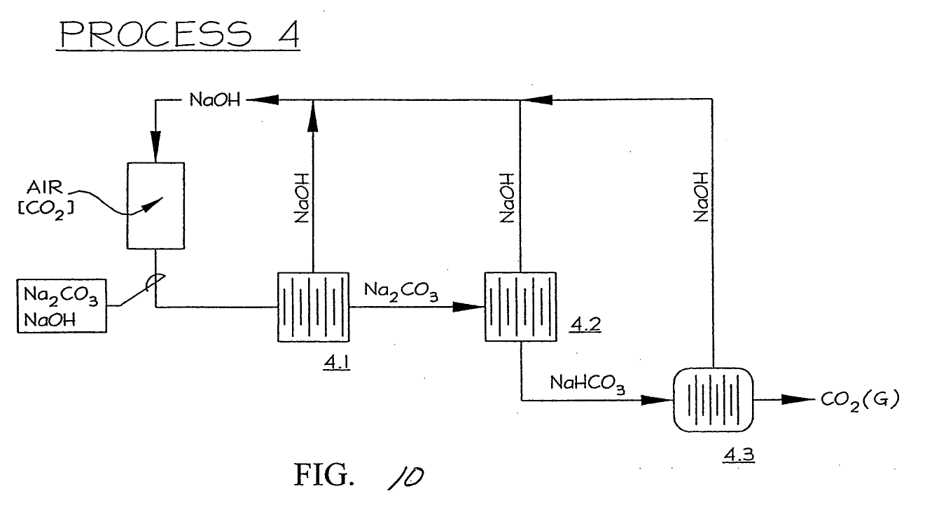

Referring to FIG. 9, for the sake of process simplicity we eliminate the step of electrochemically separating sodium carbonate into sodium hydroxide and sodium bicarbonate. Instead we use the weak acid directly to produce CO₂. This implementation is included for its simplicity, and because it allows to take advantage of the future state of the art, that may have reached extremely efficient implementations for acid/base separation in some specific acid/base pair. It is of course possible to also generate a hybrid process where steps 1.1 and 2.1 may be pushed further than just to the carbonate boundary. As another alternative one could use the electrochemical separation in 1.2 and 2.2 but stop short of the full formation of sodium bicarbonate.

Step 3.1

This step separates sodium carbonate from the sodium hydroxide in the input brine. This step could either be accomplished as in Step 1.1 or as in Step 2.1. It could also completely be eliminated by introducing a hydroxide carbonate mixture into step 3.2.

Step 3.2

This step is the analog to Steps 1.3 and 2.3 but it requires twice as much acid. The advantage of such an implementation is a substantial streamlining of the flow sheet.

Step 3.3

The step is the analog to Steps 1.4 and 2.4, but it produces twice as much acid.

Process 4:

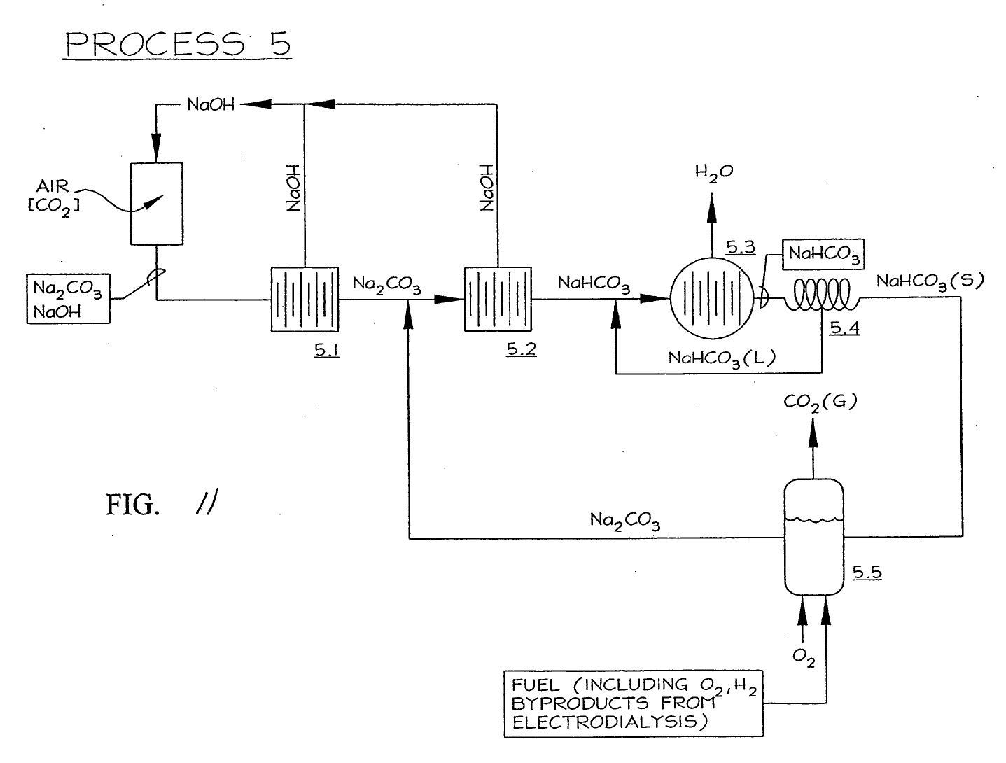

Referring to FIG. 10, process 4 starts out like processes 1 and 2, but then replaces the acid decomposition with a bipolar membrane process that drives the CO₂ out of solution.

Step 4.1

This step is the same as Step 1.1 or Step 2.1

Step 4.2

This step is the same as Step 1.2 or Step 2.2

Step 4.3

Electrochemical separation of NaHCO₃ into CO₂ and NaOH. This is based on electrodialysis with bipolar membranes. In order to obtain high pressure CO₂ the electrodialysis unit should be put into a pressure vessel, which maintains the desired CO₂ pressure over the cell. For this reason it would be desirable not to combine steps 4.2 and 4.3 as this would increase the size of the unit that needs to be maintained at pressure. It is however possible to combine the two units into one. The advantage of such a design would be a reduction in process steps. It would even be possible to combine all three units into one. Other implementations would use other electrochemical means, as for example an electrolysis system that on the cathode generates hydrogen and for the anode uses a hydrogen electrode that consumes the hydrogen produced at the cathode.

Process 5:

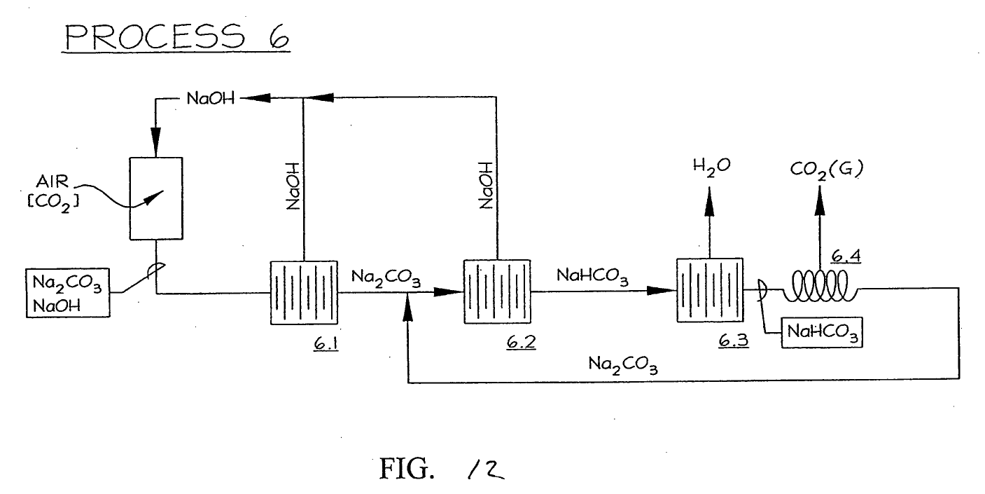

Process 5 and 6 extract CO₂ from the bicarbonate brine producing at least in part sodium carbonate and thus introduces a new recirculation loop between the final steps and the upstream steps. Process 5 precipitates out sodium bicarbonate whereas process 6 implements an aqueous version of the process. As a result these processes are well suited for implementations that only produce carbonate and use this carbonate as a fresh sorbent for CO₂ capture. Refer to FIG. 11:

Step 5.1

This step is the same as in Step 1.1 or Step 2.1

Step 5.2

This step is the same as in Step 1.2 or Step 2.2. However, the input to this unit is in part derived from process 5.1 and in part from recycled sodium carbonate derived from Step 5.5

Step 5.3

Increase the concentration of bicarbonate through water removal. This is best accomplished by letting water pass through water permeable membranes into concentrated brines. There are two possible sources for these brines (1) the concentrated brines that leave the air contactor; this is particularly useful if Step 5.1 follows 2. 1; and (2) the concentrated brines that are derived from Step 5.1 if it is analogous to 1.1 and results in solid sodium carbonate precipitate. The result is a concentrated brine of sodium bicarbonate. It needs to be contained in an air tight container so as to contain the higher than ambient CO₂ partial pressure over the solution.

Another option for dewatering the brine is to run a conventional electrodialysis unit (without bipolar membranes) in reverse. Rather than using the pure water, which will be reused elsewhere in the cycle (the total system loses water), the concentrated brine on the other side of the membrane will be collected for further use. The advantage of this approach is that it requires smaller volumes to pass through membranes, but it requires an electromotive force to succeed.

Step 5.4

Temperature swing to precipitate sodium bicarbonate from the brine. The temperature swing is not as efficient as the temperature swing for the precipitation of Na₂CO₃. However, operating between 25 and 0C would allow one to remove roughly ⅓ of the bicarbonate. Heat exchange between input and output minimizes heat losses in the system. The remaining brine is sent back to Step 5.3 for further dewatering.

Step 5.5

Calcination of solid sodium bicarbonate to form sodium carbonate and pressurized CO₂. In order to pressurize the CO₂, the calciner is contained in a pressure vessel. Such a system could utilize various sources of waste heat, e.g. from a refinery or from a power plant. Another alternative might be solar energy which has the advantage of being carbon neutral. If fossil carbon is used the heat source should use oxygen rather than air and collect the CO₂ that results from its combustion. Hydrogen and oxygen produced in the upstream electrodialysis units would provide another CO₂ free source of energy. Alternatively, a small fraction of the sodium carbonate produced could be used in part to adsorb the CO₂ from the combustion process. This sodium bicarbonate brine is returned to 5.3 in order to be dewatered again. The remaining sodium carbonate is sent back to Step 5.2 The CO₂ stream leaves from this unit.

The advantage of this implementation is that it reduces the electricity demand and replaces it in part with low grade heat. This method is therefore particularly useful in regions where electricity is expensive, or very CO₂ intensive. Methods 1-4 are advantageous in regions with low cost, low carbon electricity. E.g., hydroelectricity or excess wind power from a large wind mill farm.

Process 6:

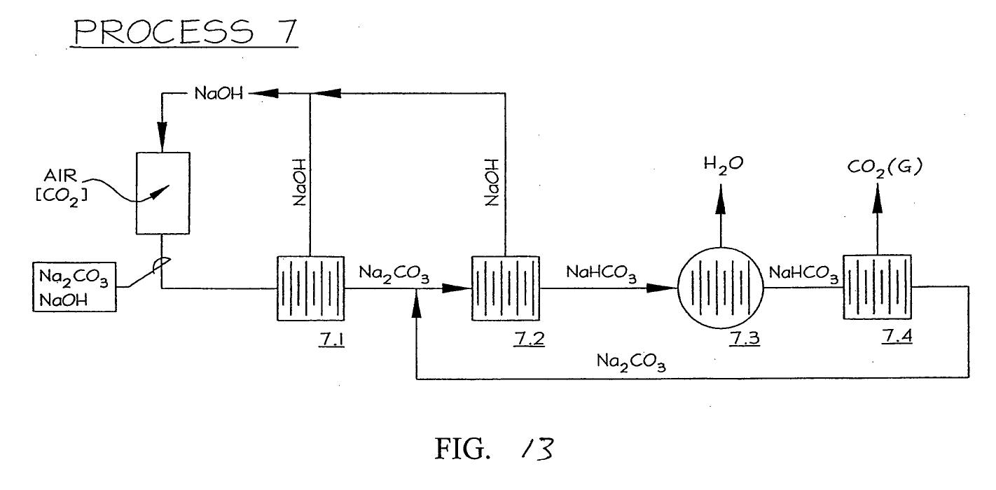

Process 6 is similar to Process 5, but it replaces the precipitation/calcination with a thermal decomposition of sodium bicarbonate directly in solution. The advantage of Process is that it easily can achieve high pressure in the CO₂ stream, whereas Process 6 is easier to implement and it follows conventional processing streams. Referring to FIG. 12:

Step 6.1

This step is the same as Step 5.1

Step 6.2

This step is the same as Step 5.2

Step 6.3

This step is the same as Step 5.3, but concentrations can be kept lower than in 5.3 and in some implementations it could be omitted.

Step 6.4

Temperature swing to heat the solution to remove CO₂ from the brine and return a brine enriched in sodium carbonate back to Step 6.2. Heat exchangers are used to minimize energy demand. Water condensation can be managed inside the unit. See discussion below. Potential heat sources are similar to those listed in Step 5.5. A fraction of the brine produced in 6.2 can be used to absorb CO₂ produced in the heat generation. The resulting sodium carbonate rich brine is returned to Step 6.2.

Process 7:

Process 7 is similar to 5 and 6 in that it operates the CO₂ generating unit strictly between bicarbonate and carbonate and that it makes no attempt to drive the electrodialysis of the CO₂ generator past this point. It may indeed stop slightly before that so as to avoid creating high pH solutions. Refer to FIG. 13:

Step 7.1

This step is the same as in Step 6.1

Step 7.2

This step is the same as in Step 6.2

Step 7.3

This step is the same as in Step 6.3

Step 7.4

A cell alternating anionic and bipolar membranes with the basic brine starting out as bicarbonate solution and the acidic brine as pure water, where the applied voltage drives the bicarbonate ions and carbonate ions across the anionic membrane to create carbonic acid on the acid side, which will release CO₂. With the removal of carbonic acid anions, the brine on the basic side gradually rises in pH. The process must stop when OH⁻ concentrations start to compete with dissolved inorganic carbon. This would allow the transformation of the bicarbonate brine to a carbonate brine.

The remaining carbonate brine is sent back to the previous unit, so that after some dewatering it can be reconverted into a bicarbonate brine.

Discussion of the Processes

The processes outlined above represent different optimizations for different situations and different goals. Which one will prove optimal will depend on the typical temperatures at which the units operate, on the local cost and carbon intensity of electricity, on the progress of various electrochemical schemes to generate acid and base. As this field is still young and in flux, it is possible that over time the advantage will move more and more to the fully electrochemical designs.

Process 1 through 4 which all rely on a second acid to complete the transformation of the spent solvent into CO₂ and fresh solvent make it possible to independently optimize acid/base separation and pressurization of CO₂. The advantage of these methods is that they completely eliminate the need of compressors for driving CO₂ up to pipeline pressure. The same is true for Process 5, but for Process 6 the maximum pressure that can be achieved is limited by the temperature to which one is willing to drive the carbonate/bicarbonate brine. One advantage of Process 6 is that Step 6.4 has been implemented in the past on large scales and thus reduces cost uncertainties associated with the scale up of new processes.

Other process units may be integrated into the overall stream to deal for example with impurities. For example, the carbonate brine arriving from the air contactor should be filtered to remove dust accumulation.

While we discuss below in some detail more specialized implementations of unit processes that are optimized for our design, one can use standard implementations for all process units.

Implementation of the Separation of Carbonate into Bicarbonate and Hydroxide

In principle any implementation of an established electrochemical process for separating acid and base can be adapted for this process unit. Not all of them rely on bipolar membranes but many of them do. One we have developed for this purpose combines a series of cationic and bipolar membranes. The system ends in two standard electrodes producing hydrogen and oxygen. These will be responsible for a few percent of the total energy consumption. They can either be integrated into the process via a fuel cell or—in Processes 5 and 6, which require heat they can be combusted to produce heat without CO₂ emission.

Sodium ions follow either a concentration gradient or an electric gradient from the mixture into the next cell which is accumulating sodium hydroxide. Different sections of the cell may be working on different concentrations in order to minimize potential differences in the system. In particular, as mentioned before it is possible to include the upstream separation of hydroxide from carbonate which can be driven by concentration gradients alone. Since none of the units reach acidic pH, the proton concentration is everywhere small enough to avoid the need for compartments separated by anionic membranes. The system is therefore simpler than a conventional bipolar membrane system that needs to control proton currents. In these cells the negative ions do not leave the cell they started in. The advantage of extracting sodium carbonate from the solvent brine prior to this step is that it reduces the amount of sodium that has to pass through these membranes. However, a simplified version of the process can eliminate the first step.

Implementation of the Acid Driven CO) Generator

Mixing an acid with sodium carbonate or bicarbonate leads to the vigorous production of CO₂. If the acid is strong enough, the entire process can generate high pressures of CO₂ if the reaction is contained in a vessel that is held at the desired pressure. One possible use for such a system would be to generate CO₂ at pressures that are above pipeline pressure, eliminating the need for subsequent compression.

One possible implementation of such a system envisions three small reservoirs, one filled with acid, one filled with bicarbonate and the third filled with the salt (e.g., sodium salt) of the acid. The bicarbonate and acid are injected from their respective reservoirs into a flow channel shaped to enhance mixing of the two fluids. If the acid is weak and the reaction therefore slow, it is also possible to introduce a container vessel that is actively stirred. In the fast reactor, the mixing channel rises to a high point where the gas is separated from the liquid flow which then is channeled downward again to enter the salt solution reservoir. The injectors into the acid and base reservoir are mechanically coupled to the salt exhaust reservoir. The mechanical energy harnessed at the exit is nearly sufficient to drive the injection pumps. A direct mechanical coupling could be based on piston displacement pumps which are mechanically connected. Small turbines could similarly be coupled together. There are many state of the art approaches that allow for the mechanical coupling.

Small systems may instead operate in a batch operation where the input tanks and output tanks are separated for example by a diaphragm. When the pressure is released filling the empty input tanks forces the draining of the full output tank. Then the system is pressure isolated from its environment and CO₂ is produced as the two fluids are pumped from the input tank into the output tank. Once the output tank is full, the CO₂ line is valved off, and the cycle repeats itself. Another implementation could use pistons, which in effect replace the moving diaphragm.

It is of course also possible to provide electric coupling, by converting the output energy of the salt stream and CO₂ stream into electric power. A small mismatch in volumes could be made up by withdrawing some pressure energy from the CO₂ output line. In principle, this could be a substantial source of mechanical energy satisfying a large number of pumping needs within the overall system. One can use this ability to adjust the mismatch in strength between the carbonic acid and the acid used to drive the system.

In this way the acid production becomes a convenient way of providing mechanical energy which is removed from the exhaust carbon dioxide.

Prior to injection of the carbon dioxide into the output stream, it needs to be cleaned and dried so that it meets whatever requirements are put on it in the particular application or particular means of disposal

Water Management in A Thermal Swing CO) Generator

In heating a bicarbonate solution, the CO₂ will carry with it water vapor that needs to be condensed out. The CO₂ which will leave the solution at some pressure and will flow out of the reservoir mixed with water vapor. In the next stage it is used to preheat the incoming solution and in the process it condenses out the water vapor. The collected water is best kept out of the bicarbonate solution as increasing the brine concentration raises the CO₂ partial pressure over the solution.

The water can be used in providing input feed for creating fresh sodium bicarbonate in the electrochemical acid/base separations in Step 6.2.

Business Method

As the opportunities for the use of CO₂ in the oil industries become exhausted, work will be underway to put in place regulatory allowances for the CO₂ “credits” earned through sequestration. These “credits” then will have a market value used in a number of ways. One possibility will be for local regulatory agencies to offer a “credit certificate” to an auto manufacturer or purchaser as a means to boost fleet mileage while allowing the continued use of popular vehicle designs that may not perform to desired levels.

It is not unreasonable to for see the time when an automobile or truck may be driven with conventional internal combustion technology (or advanced propulsion systems relying on hydrocarbon fuels) while at the same time making the claim as a zero emission automobile since sufficient CO₂ had already been removed from the atmosphere through this process. This might be arranged as an accessory certificate attached to the purchase price of the automobile or truck, or as a regulatory demand placed upon the transportation industry or some other arrangement yet to be defined. Or a socially conscious person may “buy-out” carbon upfront, i.e., at the time of purchase of an automobile.

Other Utilities

While the invention has particular utility in extracting CO₂ from the air, the air scrubber of the invention may be used for removing other gases from the air by employing a different sorbent material.

What is claimed is:

1. A method for capturing carbon dioxide from air, which comprises exposing solvent covered surfaces to air streams where the air streams have a flow that is kept laminar, or close to a laminar regime.

2. The method of claim 1, comprising one or more of the following features:
(a) wherein the surfaces comprise smooth parallel plates;
(b) wherein the surfaces are not entirely flat, and follow straight parallel lines in the direction of the airflow;
(c) wherein the surfaces comprise corrugations, pipes, tubes, angular shapes akin to harmonica covers, or any combination thereof, but with the air flow skill following a straight line.;
(d) wherein the surfaces are roughened with grooves, dimples, bumps or other small structures that are smaller than the surface spacing, and wherein these surface structures remain well within the laminar boundary of the air flow;
(e) wherein the surfaces are roughened with grooves, dimples, bumps or other small structures, and the Reynolds number of the flow around these grooves, dimples, bumps or other small structures is small, in an optimum it is between 0 and 100;
(f) wherein the surface is roughened through sand blasting or other similar means;
(g) wherein the surface is roughened through etching or other similar means;
(h) wherein the surfaces are on plates made from steel or other hydroxide resistant metals;
(i) wherein the surfaces are on plates made from glass;
(j) wherein the surfaces are on plates made from plastic, preferably polypropylene; and
(k) wherein the surfaces have been coated or treated to increase hydrophilicity of the plates.

3. The method of claim 1, wherein the surfaces are foils or other thin films that are held taught by wires and supported by taught wire or wire netting.

4. The method of claim 3, comprising one or more of the following features:
(a) wherein all wires but a few supporting wires in the front and the back run parallel to the wind flow direction;
(b) wherein the foil or film is supported on a rigid structure that could be a solid plate, a honeycomb, or lattice work that can lend structural rigidity to the films;
(c) wherein the films are made from plastic foils; and
(d) wherein the films are made from plastic foils which have been surface treated to increase the hydrophilicity of the surface.

5. The method of claim 1, comprising one or more of the following features:
(a) wherein the direction of the air flow is horizontal;
(b) wherein the surfaces—or the line of symmetry of the surfaces—is vertical;
(c) wherein the liquid solvent flow is at about a right angle to the airflow direction;
(d) wherein the surface spacing is from about 0.3 cm to about 3 cm;
(e) wherein the surface length is at about a right angle to the airflow direction, and is from about 0.30 m to about 10 m;
(f) wherein the airflow speed is from about 0.1 m/s to about 10 m/s;
(g) wherein the distance of airflow between the surfaces is from about 0.10 m to about 2 m;
(h) wherein liquid solvent is applied by means of spraying a flow onto the upper edge of the surface;
(i) wherein the solvent is applied to both sides of the plates;
(j) wherein the solvent is applied in a pulsed manner;
(k) wherein the liquid solvent is collected at the bottom of the surfaces or plates;
(l) wherein the liquid solvent is collected at the bottom of the surfaces or plates, and the collected fluid is immediately passed on to a recovery unit;
(m) wherein the liquid solvent is collected at the bottom of the surfaces or plates, and the collected fluid is recycled to the top of the scrubbing unit for additional CO₂ collection;
(n) wherein the apparatus further comprises and is equipped with air flow straighteners to minimize losses from misalignment between the surfaces and the instantaneous wind field; and
(o) wherein the apparatus further comprises and is equipped with mechanisms that either passively or actively steer the surfaces so that they point into the wind.

6. A laminar wind scrubber that utilizes pressure drops created by natural air flows comprising:
(a) wind stagnation in front of the scrubber;
(b) a pressure drop created by flows substantially orthogonal to the entrance and/or exit into the scrubbers; or
(c) a pressure drop created by thermal convection.

7. A scrubber of claim 6, comprising one or more of the following features:
(a) wherein the pressure drop is created in a cooling tower or by thermal convection along a hill side;
(b) comprising a plurality of lamella wetted at least in part by a liquid sorbent; and
(c) wherein spacing between lamella is chosen such that the system does not transition a laminar flow regime, and preferably is about 2 to 4 mm.

8. The method of claim 1, wherein the surfaces are rotating disks where wetting is helped by the rotary motion of the disks and the air is moving at right angle to the axis.

9. The method of claim 8, comprising one or more of the following features:
(a) wherein the axis is approximately horizontal and the disks dip into the solvent at their rim and the circular motion promotes distribution of the fluid on the disks;
(b) wherein the liquid is sprayed onto the disk as it moves by a radially aligned injector; and
(c) wherein the liquid is extruded onto the disk near the axis.

10. The method of claim 1, wherein the surfaces are concentric tubes of circular or other cross-section shape with the air flowing in the direction of the tube axis.

11. The method of claim 10, comprising one or more of the following features:
(a) wherein the tubes rotate around the center axis;
(b) wherein the tubes have axis oriented approximately vertically and solvent is applied in a manner that it flows downward on the surfaces of the tube; and
(c) wherein the tubes have axis oriented at an angle to the vertical and the solvent is inserted at a single point at the upper opening and flows downward in a spiral motion covering the entire surface.

12. The method of claim 1, wherein the solvent is a hydroxide solution.

13. The method of claim 12, comprising one or more of the following features:
(a) wherein the hydroxide concentration is between 0.1 and 20 molar;
(b) wherein the hydroxide concentration is between 1 and 3 molar;
(c) wherein the concentration of the solution exceeds 3 molar;
(d) wherein the concentration of the solution has been adjusted to minimize water losses or water gains;
(e) wherein where the concentration of the solution is allowed to adjust itself until its vapor pressure matches that of the ambient air;
(f) wherein the hydroxide is sodium hydroxide;
(g) wherein where the hydroxide is potassium hydroxide;
(h) wherein the solvent is a hydroxide solution where additives or surfactants have been added;
(i) wherein the solvent is a hydroxide solution containing additives or surfactants which increase the reaction kinetics of CO₂ with the solution;
(j) wherein the solvent is a hydroxide solution containing additives to reduce the water vapor pressure over the solution;
(k) wherein the solvent is a hydroxide solvent containing additives or surfactants which change the viscosity or other rheological properties of the solvent; and
(l) wherein the solvent is a hydroxide solvent containing additives or surfactants which improve the absorption properties of the solvent to scrub gases other than CO₂ from the air.

14. A method of creating tradable carbon credits which comprises extracting carbon dioxide from ambient air at a location remote from where the carbon dioxide was generated, using an absorbent, and selling, trading or transferring the resulting carbon credits to a third party.

15. The method of claim 14, wherein the carbon dioxide is captured from ambient air by the process of claim 1.

16. The method of claim 14, wherein the carbon dioxide is captured from ambient air using the apparatus of claim 6.

17. The method of claim 14, wherein a carbon credit is sold, traded or transferred with the sale or lease of an automobile or truck or with fuel for the automobile or truck.

18. The method of claim 14, wherein a carbon credit is sold by a producer of a hydrocarbon fuel.

19. A method for separating a hydroxide/carbonate brine into hydroxide and CO₂, wherein the brine is first concentrated to approach the carbonate saturation point; the concentrated hydroxide carbonate brine is subsequently separated through thermal swing precipitation of the carbonate from the brine; the carbonate is electrochemically separated into sodium hydroxide solution and sodium bicarbonate solution in a first electrochemical process step; the bicarbonate is mixed with an acid to release carbon dioxide and the acid is recovered from its salt in a second electrochemical process step.

20. The method of claim 19, comprising one or more of the following features:
(a) wherein the sodium hydroxide solution and the sodium bicarbonate solution are separated from the brine by electrodialysis with bipolar membranes;
(b) wherein the second electrochemical process comprises electrodialysis with bipolar membranes;
(c) wherein the brine is processed without initial concentration;
(d) wherein at least some of the carbonate is separated from the hydroxide in the second electrochemical process step;
(e) wherein acid is used to neutralize the brine before it releases CO₂;
(f) wherein acid injection is used to neutralize the brine before it releases CO₂, said acid injection is accomplished in a first low pressure unit that adjusts the mixture to a pH level that supports the formation of bicarbonate, and a second high pressure system that generates CO₂;
(g) wherein CO₂ is released by an electrochemical process in a pressure vessel so as to provide high pressure CO₂;
(h) wherein the CO₂ is released in an electrochemical process which comprises electrodialysis with bipolar membranes;
(i) wherein the CO₂ is released in an electrochemical process which generates hydrogen on the cathodes and uses it again in a hydrogen anode.
(j) wherein the carbonate is separated from the hydroxide at a last step; and
(k) wherein all or part of the hydroxide and the carbonate are separated in a CO₂ releasing step.

21. A method for partially separating a hydroxide/carbonate brine into a hydroxide solution and a carbonate solution in a device that separates a volume into cells by means of membranes which alternate between bipolar membranes and cationic membranes, and fluid flowing in every other chamber is a concentrated hydroxide/carbonate brine whereas in the alternating chamber flows a dilute NaOH solution with sodium ions transferring across the cationic membranes and the bipolar membranes providing the necessary hydroxide ions and protons to maintain charge neutrality.

22. The method of claim 21, comprising one or both of the following features:
(a) wherein the cells are arranged in a stack having a liquid connection between the first and the last cell which contain brines of the same type;
(b) wherein the cells are arranged in a toroidal shape; and
(c) wherein the cells are arranged in a stack which comprises two separate cells.

23. A method for separating a hydroxide/carbonate brine into a hydroxide solution and CO₂ which uses an electrochemical process to separate the hydroxide solution from the carbonate solution; and the carbonate is electrochemically separated into sodium hydroxide solution and sodium bicarbonate solution in a first electrochemical process step; the bicarbonate is mixed with an acid to release carbon dioxide; and the acid is recovered from its salt through a second electrochemical process step.

24. The method of claim 21, comprising one or more of the following features:
(a) wherein the sodium hydroxide solution and the sodium bicarbonate solution are separated from the brine by electrodialysis with bipolar membranes;
(b) wherein the electrochemical process for recovering the acid from its salt comprises electrodialysis with bipolar membranes;
(c) wherein the brine is processed without initial concentration;
(d) wherein at least some of the carbonate is separated from the hydroxide in the second electrochemical process step;
(e) wherein acid is used to neutralize the brine before it releases CO₂;
(f) wherein acid injection is used to neutralize the brine before it releases CO₂, said acid injection is accomplished in a first low pressure unit that adjusts the mixture to a pH level that supports the formation of bicarbonate, and a second high pressure system that generates CO₂;
(g) wherein CO₂ release is accomplished by an electrochemical process.
(h) wherein the CO₂ is released by an electrochemical process in a pressure vessel so as to provide high pressure CO₂;
(i) wherein the CO₂ is released in an electrochemical process which comprises electrodialysis with bipolar membranes;
(j) wherein the CO₂ is released in an electrochemical process which generates hydrogen on the cathodes and uses it again in a hydrogen anode.
(k) wherein the carbonate is separated from the hydroxide at a last step; and
(l) wherein all or part of the hydroxide and the carbonate are separated in a CO₂ releasing step.

25. The method of claim 19, wherein the sodium bicarbonate is subjected to thermal decomposition into sodium carbonate and CO₂ followed by recycling of the sodium carbonate to an earlier stage of the process.

26. The method of claim 25, comprising one or more of the following features:
(a) wherein the bicarbonate solution is reduced in water content through membrane separation by concentration gradients or electrochemical gradients (reverse electrodialysis), bicarbonate is extracted from the concentrated brine in a thermal swing precipitation followed by a thermal calcination of the bicarbonate to CO₂ and carbonate, and a resulting dilute bicarbonate output stream is recycled to another dewatering of the bicarbonate solution;
(b) wherein the bicarbonate solution is heated until CO₂ is released resulting in a carbonate/bicarbonate brine which is electrochemically reprocessed to bicarbonate;
(c) wherein the bicarbonate solution evolves CO₂ inside a pressure vessel;
(d) including a heat exchange between inputs and outputs of the thermal steps to minimize energy consumption;
(e) wherein dilute water streams generated are kept out of the brines and treated as off-water;
(f) wherein dilute water streams are used as make-up water in the input in an air contactor unit;
(g) wherein the base ion is sodium;
(h) wherein the base ion is potassium.
(i) wherein the base ion is a mixture including sodium and potassium; and
(j) wherein the base comprises an organic base.

27. The method of claim 21, wherein the sodium bicarbonate is subjected to thermal decomposition into sodium carbonate and CO₂ followed by recycling of the sodium carbonate to an earlier stage of the process.

28. The method of claim 27, comprising one or more of the following features:
(a) wherein the bicarbonate solution is reduced in water content through membrane separation by concentration gradients or electrochemical gradients (reverse electrodialysis), bicarbonate is extracted from the concentrated brine in a thermal swing precipitation followed by a thermal calcination of the bicarbonate to CO₂ and carbonate, and a resulting dilute bicarbonate output stream is recycled to another dewatering of the bicarbonate solution;
(b) wherein the bicarbonate solution is heated until CO₂ is released resulting in a carbonate/bicarbonate brine which is electrochemically reprocessed to bicarbonate;
(c) wherein the bicarbonate solution evolves CO₂ inside a pressure vessel;
(d) including a heat exchange between inputs and outputs of the thermal steps to minimize energy consumption;
(e) wherein dilute water streams generated are kept out of the brines and treated as off-water;
(f) wherein dilute water streams are used as make-up water in the input in an air contractor unit.
(g) wherein the base ion is sodium;
(h) wherein the base ion is potassium;
(i) wherein the base ion is a mixture including sodium and potassium; and
(j) wherein the base comprises an organic base.

29. A device for generating CO₂ by mixing acid and bicarbonate comprising in combination: a reservoir for holding an acid, a reservoir for holding a base, and a reservoir for holding a product salt; a line in fluid communication with the acid and base reservoirs, said line having a structure for enhancing mixing; a gas separation unit for feeding CO₂ under pressure to an exit pressure valve, said gas separation unit being connected to the salt reservoir; and an exit line from the salt brine reservoir mechanically coupled to pumps feeding acid and base into the acid and base holding reservoirs, respectively.

30. The device of claim 29, comprising one or more of the following features:
(a) wherein the CO₂ provides the bulk of the pumping power requirements to the device;
(b) further including a device for converting excess pressure on the CO₂ exit valve into usable power; and
(c) wherein excess pressure is converted into useable power which is channeled to the two input pumps or could be used elsewhere.

31. A device for generating CO₂ by mixing an acid and a bicarbonate, which comprises: three reservoirs, one for holding an acid, one for holding a base, and one for holding a product salt, said reservoirs being separated from one another by membranes, said device being operated in a batch mode where fresh fluid is loaded at ambient pressure and the fluid is pressurized during the production of CO₂.

32. A device for separating an alkaline carbonate brine into a cation and bicarbonate, said device including an anode and a cathode to which power is delivered whereupon the cation is moved across the cationic membrane whereby to convert the initial brine to bicarbonate while the brine gradually accumulates as a pure hydroxide solution.

33. The device of claim 32, wherein the cation is sodium or potassium, or an ion that will not precipitate from the solution.

34. A device for separating CO₂ from a bicarbonate brine containing CO₂, which device comprises: a reservoir having acidic cells and basic cells separated by anionic membranes alternating with bipolar membranes for producing in a stream bicarbonate ions which is mixed with acid in the acidic cells which produces CO₂, and leaving behind in the basic cells a residual brine enriched in carbonate ions.

35. A method for the separation of carbon dioxide from a hydroxide brine as claimed in claim 25 wherein the thermal decomposition step is replaced with an electrochemical process as claimed in claim 34.

36. The method of claim 35, wherein the CO₂ producing unit is pressurized to deliver a concentrated stream of CO₂.

37. A method for the separation of carbon dioxide from a hydroxide brine as claimed in claim 27 wherein the thermal decomposition step is replaced with an electrochemical process as claimed in claim 36.

38. The method of claim 37, wherein the CO₂ producing unit is pressurized to deliver a concentrated stream of CO₂.
